(19) United States
(12) Patent Application Publication
(10) Pub. No.: US 2006/0145016 A1
(43) Pub. Date: Jul. 6, 2006

(54) Mating of spacecraft components using shape memory materials

(75) Inventor: John W. Renfro, Newport Beach, CA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: THE BOEING COMPANY, Chicago, IL (US)

(21) Appl. No.: 11/026,950

(22) Filed: Dec. 30, 2004

(51) Int. Cl. B64G 1/00

(52) U.S. Cl. 244/158.1

(57) ABSTRACT

A method and apparatus is provided for mating (e.g., structurally and sealingly securing) two components of a spacecraft to one another. The apparatus and method may include a first spacecraft component having a first mating surface, a second spacecraft component having a second mating surface adapted to align with the first mating surface, and a shape memory ring constructed from a shape memory material, adapted to mate the first mating surface to the second mating surface when subjected to a temperature change.

### BACKGROUND OF THE INVENTION

1. Field of the Invention

The invention relates generally to spacecraft assembly and, more specifically, to joining spacecraft components (e.g., in orbit about the earth) to form spacecraft structures, such as, for example, pressurized spacecraft modules.

2. Background Description

Attachment devices required to assemble primary structural components, such as pressure vessels used in spacecraft that need to be assembled in space, are typically complex and extremely expensive. Such devices must meet very high reliability requirements since once in orbit, little can be done to remedy problems with the devices. In addition, pressure vessels used in spacecraft must typically be delivered into orbit in a single piece, resulting in the size of the pressure vessel being limited by the payload volume of the launch vehicle that is used to place the pressure vessel in orbit. Attaching two large pressurized vessels on orbit has not been accomplished without substantial mating hardware (e.g., complex docking systems) between them.

The present invention is directed to overcoming one or more of the problems or disadvantages associated with the prior art.

### SUMMARY OF THE INVENTION

In accordance with one aspect of the invention, a mating apparatus, including a shape memory ring, is provided for joining together two components of a spacecraft. The shape memory ring is constructed from a shape memory material, and may provide a structural connection as well as a sealing ring for the spacecraft. The mating apparatus according to one aspect of the invention provides drastically reduced complexity and provides additional benefits such as, for example, reduced payload mass and volume, high reliability, and the ability to attach two sections of a spacecraft together (e.g., to form a large pressurized volume), with minimal intrusion into the interior volume of the spacecraft. The shape memory ring may be used to provide a continuous mechanical clamp around the entire circumference of the spacecraft and may eliminate the need for discrete fasteners and latches that would require separate mechanical actuation mechanisms.

In accordance with another aspect of the invention, a method of mating two components of a spacecraft together is provided. The method includes placing a first spacecraft component in close proximity to a second spacecraft component, providing a shape memory ring, made from a shape memory material, around a mating interface, and altering the temperature of the shape memory ring (e.g., by heating the shape memory ring) to contract and secure a mating interface in place. The shape memory ring may be electrically heated to cause the shape memory ring and/or a bias ring to contract around clamping ridges provided on mating rings associated with each of the spacecraft components.

The features, functions, and advantages can be achieved independently in various embodiments of the present invention or may be combined in yet other embodiments.

### BRIEF DESCRIPTION OF THE DRAWINGS

FIG. 1 is a perspective view of an exemplary spacecraft pressure vessel that may incorporate a mating system for pressure vessels in accordance with an aspect of the invention;

FIG. 2 is an enlarged perspective view of the mating system that may be used to form the spacecraft pressure vessel of FIG. 1;

FIG. 3 is a perspective view in partial cross-section of a mating system in a docked, unclamped configuration;

FIG. 4 is a view similar to that of FIG. 3 of the mating system in a sealed, clamped configuration;

FIG. 5 is a plan view of a mating ring assembly according to a first alternative embodiment of the invention;

FIG. 6 is a cross-sectional view of the mating ring assembly of FIG. 5 taken along lines 6-6 of FIG. 5;

FIG. 7 is a cross-sectional view of a mating ring assembly according to a second alternative embodiment of the invention, showing the mating ring assembly and a first cylindrical pressure vessel component in a stowed configuration;

FIG. 8 is a cross-sectional view of the mating ring assembly of FIG. 7 in an open configuration, additionally showing a second cylindrical pressure vessel component being mated with the cylindrical pressure vessel component;

FIG. 9 is a cross-sectional view of the sealing ring assembly of FIGS. 7 and 8 in a clamped configuration;

FIG. 10 is a cross-sectional view of a mating ring assembly according to a third alternative embodiment of the invention in a stowed configuration;

FIG. 11 is a cross-sectional view of the mating ring assembly of FIG. 10 in an open configuration;

FIG. 12 is a cross-sectional view of the mating ring assembly of FIG. 10 in a clamped configuration;

FIG. 13 is a cross-sectional view of a mating ring assembly according to a fourth alternative embodiment of the invention in a stowed configuration;

FIG. 14 is a cross-sectional view of the mating ring assembly of FIG. 13 in an open configuration;

FIG. 15 is a cross-sectional view of the mating ring assembly of FIG. 13 in a clamped configuration;

FIG. 16 is a cross-sectional view of a mating ring assembly according to a fifth alternative embodiment of the invention in a stowed configuration;

FIG. 17 is a cross-sectional view of the mating ring assembly of FIG. 16 in an open configuration;

FIG. 18 is a cross-sectional view of the mating ring assembly of FIG. 16 in a clamped configuration;

FIG. 19 is a cross-sectional view of a mating ring assembly according to a sixth alternative embodiment of the invention in a stowed configuration;

FIG. 20 is a cross-sectional view of the mating ring assembly of FIG. 19 in an open configuration; and

FIG. 21 is a cross-sectional view of the mating ring assembly of FIG. 19 in a clamped configuration.

### DETAILED DESCRIPTION

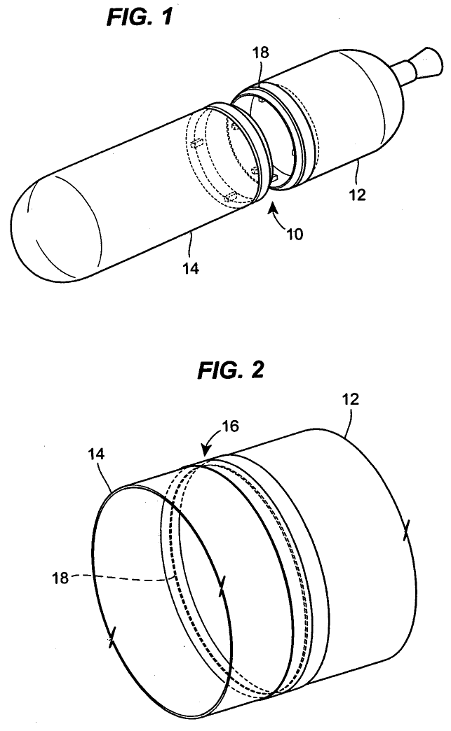

With reference initially to FIG. 1, a spacecraft pressure vessel is generally indicated at 10. The spacecraft pressure vessel 10 may be, for example, a spacecraft module, and may include a first cylindrical spacecraft component 12 and a second cylindrical spacecraft component 14.

An overall view of an example of a docking system 16 that may be used to structurally and sealably connect the first cylindrical spacecraft component 12 to the second cylindrical spacecraft component 14 in accordance with one aspect of the invention is shown in FIGS. 1 and 2. The docking system 16 may include a shape memory ring 18, made from a shape memory material, such as, for example, a shape memory alloy material. An example of a shape memory alloy material that may be suitable for use in forming the shape memory ring 18 is Nickel Titanium, also known as NiTi or Nitinol. Shape memory alloys have unique properties that permit them to undergo a solid state phase change when heated (e.g., from a deformed martensite phase to an austenite phase). As will be described in further detail below, the shape memory ring 18 may provide a structural connection as well as a sealing ring for the spacecraft pressure vessel 10.

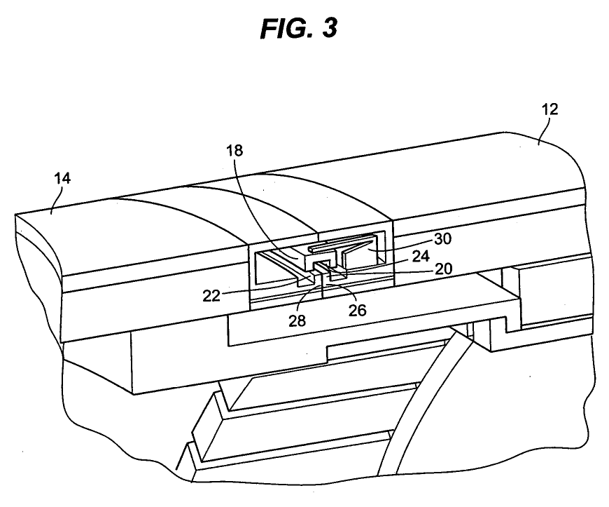

In order to join the first cylindrical spacecraft component 12 to the second cylindrical spacecraft component 14, the first cylindrical spacecraft component 12 and the second cylindrical spacecraft component 14 may be placed in close proximity to one another using a capture procedure (e.g., using any suitable means, such as thrusters, torquers, reaction wheels, etc. to properly position the respective components, and/or using any suitable grappling mechanisms to maintain the respective components in close proximity to one another). As described in further detail below in connection with FIGS. 3 and 4, after capture, a structural connection and pressure seal at a mating interface between the first cylindrical spacecraft component 12 and the second cylindrical spacecraft component 14 may be created by heating the shape memory ring 18. This may be accomplished, for example, using an electrical heating system that uses the inherent resistance of a shape memory alloy material that may be used to form the shape memory ring 18.

As seen in FIGS. 3 and 4, the shape memory ring 18 may have a U-shaped cross sectional geometry, and each of the first cylindrical spacecraft component 12 and the second cylindrical spacecraft component 14 may include a clamping ridge, 20 and 22, respectively, that, when abutted against one another, may together engage a circular groove 24 that is defined by the U-shaped cross sectional geometry of the shape memory ring 18.

When the shape memory ring 18 is heated to a phase change temperature, a resulting phase change from a deformed martensite phase (FIG. 3) to an undeformed austenite phase (FIG. 4) forces the shape memory ring 18 to contract around the clamping ridges 20 and 22. This results in ring compression around mating surfaces 26 and 28 adjacent to the clamping ridges 20 and 22, respectively, as shown in FIG. 4. The shape memory ring 18 thus forms a continuous mechanical clamp around the entire circumference of the clamping ridges 20 and 22, and eliminates the need for discrete fasteners and latches, which would have required mechanical actuation mechanisms.

Guide members 30 may be provided at various positions around the circumference of the first cylindrical spacecraft component 12, in order to maintain the shape memory ring 18 in a proper position (e.g., in alignment with the clamping ridges 20 and 22) before and during heating of the shape memory ring 18. Heating of the shape memory ring may be accomplished, for example, by passing an electric current through the shape memory ring 18, using the resistance of the shape memory ring 18 to heat the shape memory ring 18 to a temperature at which it transitions from the martensite phase to the austenite phase.

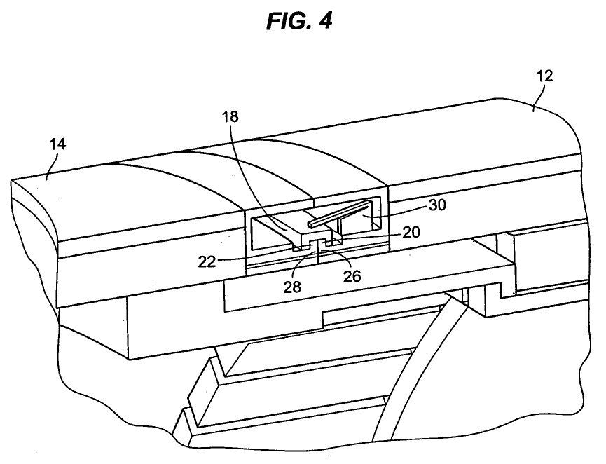

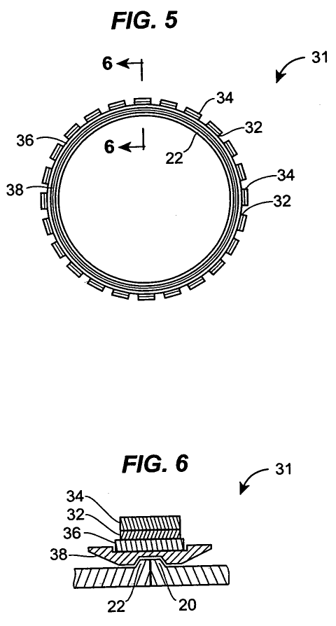

Alternatively, and as shown in FIGS. 5 and 6, a first alternative mating ring assembly 31 may include a plurality of Peltier effect modules 32 and heat sinks 34 that may be used to regulate the temperature of a flat shape memory ring 36. The flat shape memory ring 36 may be made from a shape memory material such as, for example, NiTi. A bias ring 38, that may be made from a composite material, such as, for example, a carbon epoxy composite material, may be located between the flat shape memory ring 36 and the clamping ridges 20 and 22. The bias ring 38 may be manufactured to a diameter slightly larger than that of the clamping ridges 20 and 22, to provide an expansion force on the flat shape memory ring 36. When in the austenite phase, the flat shape memory ring 36 may have a diameter slightly smaller than that which is required to force the bias ring firmly against the clamping ridges 20 and 22.

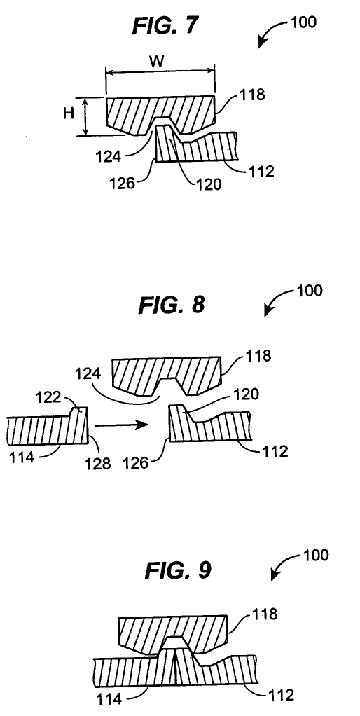

A second alternative embodiment of the invention is shown in FIGS. 7 through 9, in which a second alternative mating ring assembly 100 includes a shape memory ring 118 that may be manufactured from a shape memory material having a two-way shape memory effect and a one-way strain effect. For example, in order to achieve a difference in radius, due to the shape memory effect, of approximately one inch (2.54 centimeters) for a 15 foot (4.57 meter) diameter shape memory ring 118, a cross-sectional area of approximately 6.9 square inches (44.5 square centimeters) may be required for a material such as NiTi. Thus, the width, W, of the cross-section of the shape memory ring 118 may be approximately 5.4 inches (13.7 centimeters) and may have a cross-sectional height, h, of approximately 1.7 inches (4.3 centimeters). The shape memory ring 118 may include a wedge-shaped channel 122 that will engage clamping ridges 120 and 122 of a first cylindrical spacecraft component 112 and a second cylindrical spacecraft component 114, respectively.

In FIG. 7, the shape memory ring 118 is shown in a stowed configuration at a first or ambient temperature. In FIG. 8, the shape memory ring 118 is shown at a lowered or cooled temperature at which the shape memory effect causes an increase in radius of the shape memory ring 118 thereby providing clearance for the docking of the second cylindrical spacecraft component 114 with the first cylindrical pressure component 112. The shape memory ring 118 may then be heated back to an elevated temperature, which may be the same temperature as in the stowed configuration of FIG. 7, in order to clamp the first cylindrical spacecraft component 112 together with the second cylindrical spacecraft component 114, as shown in FIG. 9.

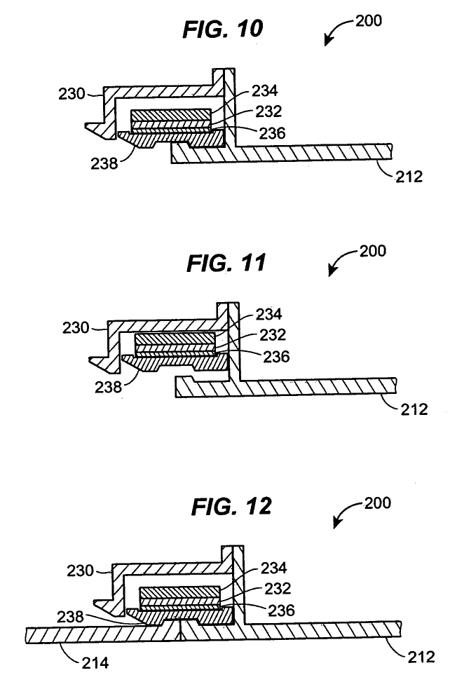

With reference to FIGS. 10 through 12, a third alternative embodiment of the invention, in which a third alternative mating ring assembly 200 may include a plurality of Peltier effect modules 232 and heat sinks 234 that surround a shape memory ring 236 that in turn surrounds a bias ring 238. The shape memory ring 236 may be made from a shape memory alloy material. A retaining/guide ring 230 may be provided, that surrounds the shape memory ring 236, the Peltier effect modules 232, the heat sinks 234, and the bias ring 238. The retaining/guide ring 230 may be attached to a transverse circular flange 240 of a first cylindrical spacecraft component 212. As depicted in FIG. 10, in a stowed configuration, the shape memory ring 236 is at a first radius such that the bias ring 238 is pressed against the first cylindrical spacecraft component 212. The shape memory ring 236 may be made from a one-way shape memory effect material, having a one-way strain effect, such that when cooled (e.g., by the Peltier effect modules 232), the shape memory ring 236 will relax and be pushed outward by the bias ring 238, as depicted in FIG. 11, thereby providing clearance for the introduction and mating of a second cylindrical spacecraft component 214 with the first cylindrical spacecraft component 212. Next, the shape memory ring 236 may be heated using the Peltier effect modules 232, to provide a smaller radius of the shape memory ring 236, thereby clamping the first cylindrical spacecraft component 212 together with the second cylindrical spacecraft component 214, as depicted in FIG. 12.

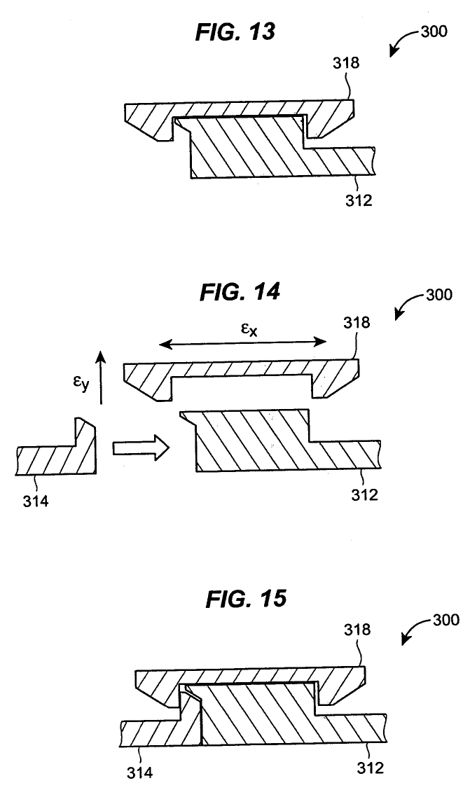

FIGS. 13 through 15 depict a fourth alternative embodiment of the invention, in which a fourth alternative mating ring assembly 300 may utilize a two-way shape memory effect and two-way strain of a shape memory ring 318 constructed from a shape memory material, is used. FIG. 13 shows the shape memory ring 318 and a first cylindrical spacecraft component 312 in a stowed configuration at a first temperature. FIG. 14 shows the shape memory ring 318 at a second lower temperature, at which the shape memory effect results in strain, εₓ, in an axial direction, as well as strain, ε_{y}, in a circumferential direction, resulting in a clearance in a channel-shaped opening 32 in which mating ridges 324 and 326 of first and second cylindrical vessel components 312 and 314, respectively may be inserted, as depicted in FIG. 14. Subsequently, the shape memory ring 318 may be re-heated such that the shape memory effect provides two-way strain thereby reducing the radius of the shape memory ring 318 as well as reducing the width of the channel-shaped opening 32 to provide both axial and radial clamping forces on the clamping ridges 324 and 326, as shown in FIG. 15.

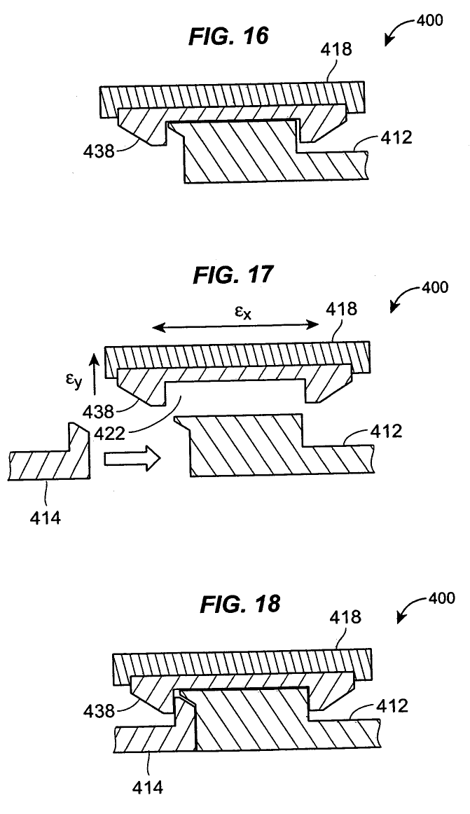

A fifth alternative embodiment of the invention is shown in FIGS. 16 through 18, in which a fifth alternative mating ring assembly 400 includes a shape memory ring 418 that may be located radially outward of a bias ring 438. FIG. 16 depicts the shape memory ring 418 and the bias ring 438 along with a first cylindrical spacecraft component 412, in a stowed configuration. By cooling the shape memory ring 418, an open configuration, as depicted in FIG. 17 may be achieved in a manner similar to that of FIG. 14. This provides a clearance in a channel-shaped opening 422 of the bias ring 438 allowing the first cylindrical spacecraft component 412 to be mated with a second cylindrical spacecraft component 414. Subsequently, the shape memory ring 418 may be re-heated to achieve a clamped configuration, as shown in FIG. 18.

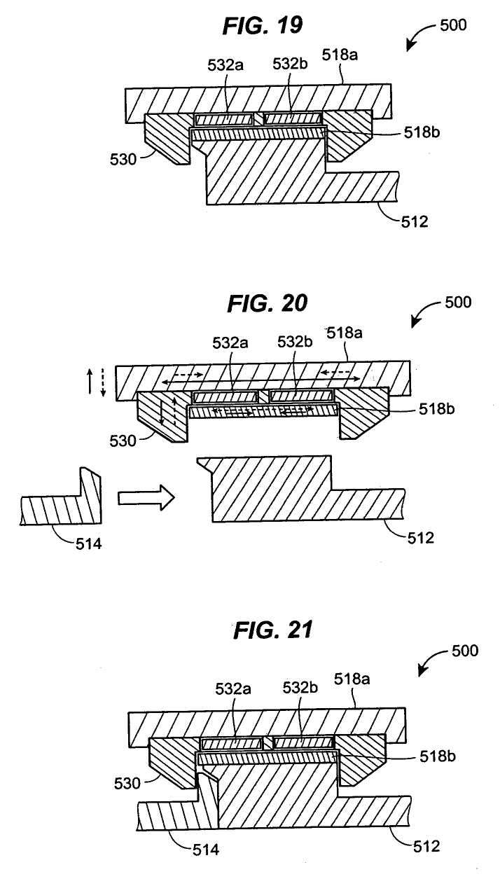

A sixth alternative embodiment of the invention is shown in FIGS. 19 through 21, in which a sixth alternative mating ring assembly 500 includes an outer shape memory ring 518a that may be located radially outward of pairs of Peltier effect modules 532a, 532b, that may be distributed circumferentially around an inner shape memory ring 518b, and located within a bias ring 530. The bias ring 530 may provide a means of load transfer between the shape memory rings 518a and 518b, while enveloping and providing a load path around the Peltier effect modules 532a and 532b.

The outer shape memory ring 518a may be made from a shape memory material that is in an undeformed (e.g., austenite) phase at a first temperature, and the inner shape memory ring 518b may be made from a shape memory material that is in a deformed (e.g., martensite) phase at the first temperature. Thus, the shape memory effects of the outer shape memory ring 518a and the inner shape memory ring 518b may counteract one another.

By transferring heat from the outer shape memory ring 518a to the inner shape memory ring 518b, a larger effective radius may be achieved, thereby placing the shape memory rings 518a and 518b in an open configuration, as shown in FIG. 20. For both of the shape memory rings 518a and 518b, the solid arrows in FIG. 20 indicate the direction of overall strain produced in the mating ring assembly 500 by cooling, and the dashed arrows in FIG. 20 indicate the direction of overall strain produced in the mating ring assembly 500 by heating. Thus, heating the outer shape memory ring 518a results in an overall compression strain (shrinkage) of the mating ring assembly 500 in the axial and circumferential directions, and heating the inner shape memory ring 518b results in an overall tension strain (expansion) of the mating ring assembly 500 in the axial and circumferential directions.

In FIG. 20, the shape memory rings 518a and 518b are shown after heat has been transferred from the outer shape memory ring 518a to the inner shape memory ring 518b. This provides additional clearance between the bias rings 530a and 530b, allowing a first cylindrical spacecraft component 512 to be mated with a second cylindrical spacecraft component 514. Subsequently, heat may be transferred from the inner shape memory ring 518b to the outer shape memory ring 518a to achieve a clamped configuration, as shown in FIG. 21.

In all of the foregoing embodiments, additional heat rejection devices (not shown) may be provided to dissipate unwanted heat.

The invention drastically reduces the complexity required to connect and seal spacecraft components, for example, to form large spacecraft pressure vessels, and provides additional benefits such as reduced payload mass and volume and high reliability. It also provides the ability to attach two sections of a pressurized volume together with minimal intrusion into the interior volume. The invention self aligns the structures together with minimal intervention and overhead, providing for autonomous assembly of large scale space structures. Other benefits include a uniform geometry, thereby simplifying the manufacturing process.

Other aspects and features of the present invention can be obtained from a study of the drawings, the disclosure, and the appended claims.

What is claimed is:

1. A mating apparatus for mating two components of a spacecraft to one another, comprising:
a first spacecraft component having a first mating surface;
a second spacecraft component having a second mating surface adapted to align with the first mating surface; and
a shape memory ring constructed from a shape memory material, adapted to structurally and sealingly connect the first mating surface to the second mating surface when heated.

2. The mating apparatus of claim 1, wherein the shape memory ring is constructed from a nickel titanium alloy material.

3. The mating apparatus of claim 1, wherein the shape memory ring includes a circular groove.

4. The mating apparatus of claim 1, wherein at least one of the first spacecraft component and the second spacecraft component includes a clamping ridge.

5. The mating apparatus of claim 1, further including a heating device.

6. The mating apparatus of claim 5, wherein the heating device is an electrical resistance heating device.

7. The mating apparatus of claim 6, wherein the shape memory ring provides a resistive element for the heating device.

8. The mating apparatus of claim 5, wherein the heating device includes at least one Peltier effect module.

9. The mating apparatus of claim 1, further including a bias ring located on the interior of the shape memory ring.

10. The mating apparatus of claim 1, further including a first shape memory ring and a second shape memory ring.

11. The mating apparatus of claim 10, wherein the second shape memory ring is disposed radially inward of the first shape memory ring.

12. The mating apparatus of claim 11, further including at least one Peltier effect module disposed between the first shape memory ring and the second shape memory ring.

13. A method of mating two components of a spacecraft together, comprising:
placing a first spacecraft component in close proximity to a second spacecraft component;
providing a shape memory ring, made from a shape memory material, around a mating interface located between the first spacecraft component and the second spacecraft component; and
altering the temperature of the shape memory ring to contract around and secure the mating interface in place.

14. The method of claim 13, wherein altering the temperature of the shape memory ring includes electrically heating the shape memory ring.

15. The method of claim 13, further including providing clamping ridges on at least one of the first spacecraft component and the second spacecraft component.

16. The method of claim 15, wherein the shape memory ring includes a circular groove that captures the clamping ridges when the temperature of the shape memory ring is altered.

17. The method of claim 13, wherein altering the temperature of the shape memory ring is performed using at least one Peltier effect module.
